(19) United States
(12) Patent Application Publication
(10) Pub. No.: US 2025/0049048 A1
(43) Pub. Date: Feb. 13, 2025

(54) APPARATUS AND METHOD FOR STUNNING POULTRY IN A STUNNING CHAMBER ABOVE GROUND

(71) Applicant: BAADER FOOD SYSTEMS DENMARK A/S, Trige (DK)

(72) Inventor: Poul Kjeldsen, Trige (DK)

(21) Appl. No.: 18/719,115

(22) PCT Filed: Dec. 16, 2021
(86) PCT No.: PCT/EP2021/086220

§ 371 Date: Jun. 12, 2024

(51) Int. Cl. A22B 3/00; A22B 5/02

(52) U.S. Cl. CPC A22B 3/005; A22B 5/02

(57) ABSTRACT

An apparatus is for gas-stunning live poultry intended for slaughter and located in containers, by a gas mixture containing a stunning gas. The apparatus has at least one stunning chamber, having at least two stunning zones, and a transport device with at least one transport conveyor for transporting the containers along at least one transport path. The stunning chamber is arranged above ground and the stunning zones lie substantially horizontally one above the other. The gas mixture of the two stunning zones has different stunning gas concentrations. The stunning gas concentration in the gas mixture of the stunning zones increases, starting from the uppermost to lowermost stunning zone. The transport device provides that the containers can be transported on the at least one transport path substantially horizontally in a meandering manner through the stunning zones along a stunning path in the stunning chamber. A corresponding method is disclosed.

### CROSS-REFERENCE TO RELATED APPLICATIONS

This application is the U.S. National Stage of PCT/EP2021/086220 filed on Dec. 16, 2021, the entire content is incorporated herein by reference in it's entirety.

### FIELD OF THE INVENTION

The invention relates to an apparatus configured and adapted for gas-stunning live poultry, which are intended for slaughter and located in containers, by means of a gas mixture containing a stunning gas, which apparatus comprises at least one stunning chamber having at least two stunning zones, at least one input station arranged on the inlet side of the stunning chamber for the containers containing live poultry and at least one output station arranged on the outlet side of the stunning chamber for the containers containing stunned poultry, a transport device with at least one transport conveyor configured and adapted for transporting the containers from the input station to the output station through the stunning chamber along at least one transport path.

The invention further relates to a method for gas-stunning live poultry, which are intended for slaughter and are located in containers, by means of a gas mixture containing a stunning gas.

### BACKGROUND OF THE INVENTION

Apparatuses and methods for gas-stunning poultry have been known for many years in prior art and are used in particular for gentle and preferably low-stress pretreatment of animals intended for slaughter. Such apparatuses and methods use carbon dioxide, for example, as the stunning gas which is given to poultry in lethal and/or stunning concentrations. Therefore, stunning refers to both the sedation (the so-called “falling asleep phase”) of the poultry into deep but reversible unconsciousness (Controlled Atmosphere Stunning=CAS) and also stunning to irreversible unconsciousness, i.e. brain death (Controlled Atmosphere Killing=CAK). The degree of unconsciousness depends on the concentration of the stunning gas in the gas mixture and/or the duration of exposure to the gas mixture containing the stunning gas, which is why stunning takes place in a plurality of phases of varying and, in particular, increasing concentration of the stunning gas in the gas mixture. Basically, before slaughter, poultry must be brought to a state of deep unconsciousness—according to individual animal welfare directives—until brain death. However, the time interval between unconsciousness, in particular when brain death has occurred, and slaughter or throat slitting or heading, which usually involves an incision into the blood vessels located in the side of the neck, must be kept to a minimum so that the heart still has a residual function at slaughter to aid in the bleeding process after throat slitting or heading.

Stunning of the poultry, which in particular includes broilers but also ducks, geese, turkeys or the like, takes place in several stages in order to comply with the relevant directives on animal welfare. For progressive stunning, the apparatuses have at least two stunning zones in which the poultry are exposed to gas mixtures with varying concentrations of the stunning gas. Carbon dioxide (CO₂) is mentioned as a stunning gas purely by way of example. However, other approved stunning gases can also be used as components of the gas mixture. According to Council Regulation (EC) 1099/2009, poultry must be completely unconscious before being exposed to a gas concentration of more than 40% stunning gas in the gas mixture. Only when the poultry are safely and completely unconscious are they exposed to a gas mixture that has a proportion of more than 40% stunning gas in the gas mixture which can lead to deep and prolonged unconsciousness (then referred to as stunned) until brain death (then referred to as killed) of the poultry. Preferably, therefore, the apparatus according to the invention also comprises at least two stunning zones, one of the stunning zones having a proportion of less than 40% stunning gas in the gas mixture and at least one further of the stunning zones having a proportion of more than 40% stunning gas in the gas mixture.

A large number of apparatuses and methods are known in which the poultry are transported through stunning chambers, e.g. on a transport conveyor or by means of an overhead conveyor. Furthermore, various apparatuses and methods are known in which poultry are guided through a stunning chamber in containers. WO 99/60861 A1 discloses a method and an apparatus for generating and maintaining a gas mixture in one or more phases as well as use of the equipment for stunning poultry. The phases can be provided by zones in a plant such as a stunning tunnel or other suitable piece of equipment. The gas mixture consists of carbon dioxide gas (CO₂) and oxygen (O₂) and possibly some air. In such methods and apparatuses, the animals pass through the existing phases with the different gas concentrations one immediately after the other, resulting in low flexibility and requiring a large amount of space. Furthermore, the inclined stunning tunnel makes it problematic to set and maintain the correct gas concentration along the transport path of the animals to be stunned.

WO 2004/64528 A1 shows a method and a system for gas-stunning of slaughter poultry in which gas-stunning of the birds takes place after the birds have been removed from the transport crates and in which the birds are conveyed successively through a stunning chamber by means of conveyors, it being possible to adjust the effect of the gas for stunning the birds by shortening or lengthening the conveying time and/or the conveying path through the stunning chamber of the birds on the conveyors. In this case, the stunning chamber is configured as a pit through which the animals to be stunned are conveyed through the stunning chamber, and thus through the individual gas concentrations, individually on inclined conveyors. The change in the conveying path is provided by telescopic conveyors which, on the one hand, are cost-, space- and maintenance-intensive and, on the other hand, provide only low flexibility when designing the stunning path.

WO 2014/184770 A1 discloses a method and an apparatus for stunning poultry. A stunning gas is fed into a closed chamber in which the poultry are transported through a plurality of successive environments between an inlet, at which the concentration of stunning gas is minimal, and an outlet, at which the concentration of stunning gas is maximal. The concentration of stunning gas increases from each environment to the next environment, initially at a minimum rate of increase and then at a higher rate of increase until the maximum concentration is reached. The chamber represents an above-ground stunning tunnel through which the poultry are conveyed downwards in cages in a step-like manner and is stunned in the process.

WO 2015/156668 A1 relates to an apparatus and a method for stunning poultry with an elongated stunning space having a poultry feed opening and a poultry discharge opening, the elongated stunning space being divided into at least two adjoining compartments, a controlled stunning gas supply adjoining the elongated stunning space and a conveyor leading through the elongated stunning space which provides a transport path for the poultry, at least one side of the elongated stunning space being connected to a transition compartment.

However, the known apparatuses and methods all have the same disadvantage that only a limited number of poultry can be stunned with a single apparatus due to the large space requirements of such apparatuses for stunning poultry. A poultry processing plant has a preset processing capacity in poultry per minute and the supply of poultry must meet the preset processing capacity. The goal of poultry processing plants is to process a continuous stream of poultry to obtain a predictable and consistent yield. In recent years, the apparatuses for further processing poultry have gradually been developed so that a higher processing capacity is possible here. For upstream stunning, this results in the requirement for an increase in processing capacity to achieve a desired target value for overall processing. Currently, the increase in stunning capacity is mainly achieved by larger stunning apparatuses or by increasing the number of stunning apparatuses within a plant which, however, is not appropriate for a large number of plants due to the high space requirements and the investment costs.

### SUMMARY OF THE INVENTION

Furthermore, the known apparatuses and methods are not flexible in the adjustability of the times taken by the poultry to pass through the apparatuses. However, as poultry are natural products that are often subject to considerable variations in anatomy, size, weight, etc., they sometimes require widely varying gassing times and concentrations to ensure the most animal-friendly as well as efficient processing. Most poultry processing plants process poultry of different sizes and weights, resulting in different numbers of poultry in the designated transport containers. In addition, different numbers of poultry are located in the transport containers during high temperatures as well as during temperature and humidity differences between summer and winter. Furthermore, poultry flocks can have been exposed to different stress factors during rearing, so that it may be necessary to increase or decrease the gassing times and/or concentrations. In addition, specific gassing times and concentrations are required for different species of poultry. Therefore, in practice, it regularly happens that the optimum gassing factors are not selected for the poultry.

A further disadvantage with the currently known stunning apparatuses which are suitable for containers or crates (containers, boxes, drawers, etc.) to pass through is that the speed of the subsequent further processing stations (e.g. killing line) cannot be adapted to a fluctuating output of stunned poultry, insofar as different times of exposure are provided for the poultry in the stunning apparatus. Buffer areas in the plant are required to ensure a constant supply of stunned poultry but this should be avoided from cost and quality aspects. Killing should follow stunning as soon as possible to prevent losses of quality.

In addition, it is necessary that stunning of the poultry proceeds with a specific gassing time and concentration. Changing the gassing duration or the gas concentration can result in over-stunning, insufficient stunning, incorrect timing (plucking problems) and bird damage (wing breakage) etc. It is essential to avoid over-stunning poultry at the wrong time to minimise the time lag between the end of stunning and bleeding. Poultry that are exposed to the gas mixture for a longer period of time or that remain in their stunned state or brain dead state for a longer period of time until they are slaughtered for bleeding do not usually have residual heart function, making bleeding more difficult after the slaughter or heading cut. In this way, waste is produced or a manual secondary operation is necessary which leads to higher processing costs or losses of quality.

It is therefore the object of the present invention to propose a simple and compact apparatus which ensures uniform and reliable stunning of all poultry and also guarantees demand-oriented conveying of the containers with the poultry intended for slaughter by means of the apparatus. The object is further to propose a corresponding method.

This object is achieved by the apparatus referred to hereinbefore in that the at least one stunning chamber is arranged above ground and the at least two stunning zones are configured and adapted to lie substantially horizontally one above the other, and in that the gas mixture of the at least two stunning zones has different concentrations of the stunning gas in each case, the concentration of the stunning gas in the gas mixture of the at least two stunning zones increasing, starting from the uppermost of the stunning zones to the lowermost of the stunning zones, and in that the transport device is configured and adapted in such a manner that the containers can be transported on the at least one transport path substantially horizontally in a meandering manner through the at least two stunning zones along a stunning path in the stunning chamber. The apparatus according to the invention ensures that the space requirement of such apparatuses is reduced, based on the increasing process capacity in a poultry plant, it being possible to generate a higher throughput of poultry by means of the horizontally meandering stunning path. At the same time, the stunning path can be variably changed by means of the present apparatus, i.e. it can be extended or reduced. Due to the meandering design in at least two stunning zones located one above the other, the process path can be extended while maintaining a constant surface. Such stunning zones can also be understood alternatively as levels or phases, each of which contains the stunning path or process path to be passed through. With the stunning zones configured and adapted horizontally one above the other, there is a clear demarcation between the gas mixtures contained therein, whereby particularly preferably a defined concentration of the stunning gas prevails in each of the stunning zones. Preferably, the containers are variably transportable through each of the stunning zones, preferably with regard to the speed, by means of the transport device. With the passage speed set accordingly, the time of exposure of the poultry and the amount of stunning gas to be administered can be set independently for each of the stunning zones. The different concentrations of the stunning gas in the gas mixture of the at least two stunning zones improves the stunning efficiency due to the possibility of adjusting the parameters of the treatment time in the various phases of the stunning process during operation. During the meandering stunning path, the apparatus according to the invention exposes the poultry in the containers to the desired different concentrations of stunning gas in the gas mixture, in the corresponding stunning zones and for a predetermined period of time, from feeding into the stunning chamber in the region of the input station to discharge in the region of the output station, for example for transfer to the subsequent slaughter process. When speaking about the transport of containers, within the meaning of the invention, this also expressly means a plurality of containers arranged one above the other, preferably in a stack. Accordingly, the containers can be single or in a plurality of containers arranged one above the other. The apparatus according to the invention can more preferably be configured and adapted in such a manner that the containers are transported through the stunning chamber in a plurality of rows side by side to increase the capacity.

Due to the spatial proximity of the stunning zones arranged horizontally one above the other, a simplified exchange between the respective stunning zones is offered, wherein in a preferred embodiment, a gas exchange between stunning zones located one above the other can be carried out, for example to increase or decrease the gas concentration of the stunning gas in the corresponding stunning zones. Alternatively, an exchange of containers into a stunning zone located above or below can preferably be carried out, for example to increase or decrease the time of exposure of the containers containing the poultry in the respective stunning zones. The arrangement of stunning zones one above the other thus allows simplified access between the stunning zones, as a result of which different conditions can quickly be adjusted. Furthermore, in this way the poultry can be discharged more quickly from the stunning chamber after stunning, since the whole apparatus takes up a small amount of space, reducing transport paths. In addition, the meandering configuration, which can alternatively be referred to, for example, as a serpentine configuration, enables utilisation of the natural differences in density of gas mixtures with different concentrations of a stunning gas, for example carbon dioxide, in order to provide a gas mixture with a different concentration of the stunning gas in each of the stunning zones located one above the other.

In particular, the apparatus is configured and adapted for gas-stunning chickens. However, the invention similarly relates to comparable poultry which are intended for slaughter. The containers are configured and adapted to receive one or a plurality of poultry and are basically free in design, although openings or at least one cover element can be provided, for example, to at least partially close the container. In the case of the containers, for example, openings can be provided, e.g. by means of ventilation openings in the region of the side walls, for example, or a mesh structure. Such containers are also alternatively referred to as crates, cases, boxes, drawers, cages, containers, chests or the like and are also to be understood as such within the meaning of the invention. Stunning chambers are broadly defined as all open or closed frames, housings, tubs, tunnels, rooms, spaces or the like, such stunning chambers preferably being closed. The stunning gas used is preferably heavier than the ambient air, such that the gas mixture with the stunning gas, if it is provided in one of the upper stunning zones, sinks towards the bottom of the stunning chamber and the highest gas concentration of the stunning gas is present there. The present invention, however, is not limited solely to the use of gases or gas mixtures for stunning that are heavier than the ambient air. Rather, stunning gases or stunning gas mixtures can also be used that are lighter than the ambient air or whose density corresponds to that of the ambient air, although in these cases it may be necessary to make adjustments to transport of the containers, e.g. by changing the transport direction and/or transport speed. Gas mixture within the meaning of the invention means both gas mixtures and also pure gases which, for example, are provided in the stunning chamber or in the stunning zones purely based on the pressure prevailing in their storage tank. Preferably, however, carbon dioxide is used as the stunning gas because of its inexpensive and safe availability.

The horizontal arrangement of stunning zones one above the other offers a high capacity with a small surface, since the different transport paths of the stunning zones are arranged on the same surface. “Substantially horizontal one above the other” means, for the purposes of the invention, one above the other either horizontal or almost horizontal, i.e. with a deviation of at most ±15°, particularly preferably at most ±5°. The at least two stunning zones lying substantially horizontal one above the other enable a compact design of the apparatus in order to configure and adapt the most comfortable transport of the containers or poultry along the stunning path within the stunning zones. The at least one stunning zone is preferably oriented parallel to the substrate or floor of the stunning chamber. The one-above-the-other arrangement results in multiple use of the surface, reducing the area built on in poultry processing plants. The above-ground arrangement also results in a cost-effective structure, since no underground pits or the like are required which in turn require increased maintenance and pose a tremendous potential hazard to operating staff. Due to the fact that carbon dioxide has a higher density than air, the stunning zones one above the other create an easy way to provide a high concentration of carbon dioxide in the lowermost of the stunning zones for stunning the poultry, since no technically demanding structures are required for the appropriate gas concentrations intended for stunning. “Above-ground”, for the purposes of the invention, means that the stunning chamber is located at least predominantly above ground, i.e. above the ground or above the slaughterhouse floor, although this does not exclude the stunning chamber from being at least slightly below the ground. Due to the above-ground and at the same time one above the other arrangement, a modular and expandable as well as demand-oriented apparatus can be provided in a simple and reliable manner, in that on the one hand further stunning zones or sections can be added, and on the other hand it is not necessary that the entire volume of the apparatus is used, so that the containers containing poultry to be stunned can be guided through only one section or a smaller number of the existing stunning zones, depending on the stunning desired or the type or size of the poultry.

A preferred embodiment is characterised in that the transport device, the input station and/or the output station comprise at least one lift device for transporting the containers substantially vertically. “Substantially vertically” means, for the purposes of the invention, either vertically or almost vertically, i.e. with a deviation of at most ±15°, particularly preferably at most ±5°. The lift device preferably runs substantially orthogonal to the at least one adjoining stunning zone. On the one hand, the at least one lift device enables transport of the containers into the stunning chamber or into the at least one stunning zone and, on the other hand, out of the at least one stunning chamber or out of the at least one stunning zone. Lift devices may be present in a single apparatus in different designs and modes of operation, however, they are at least configured and adapted to transport the containers vertically.

In a further advantageous embodiment of the invention, the transport device comprises a plurality of transport conveyors, the number of transport conveyors corresponding at least to the number of stunning zones provided. In this way, it is possible to convey the containers separately, depending on the transport path or poultry used, in order to configure and adapt a flexible transport speed or path in each of the stunning zones. At least one individual stunning zone preferably has a plurality of transport conveyors. For example, by having a plurality of transport conveyors within a single stunning zone, the existing transport conveyors can be configured and adapted for different speeds or gaps of specific containers.

An advantageous development is characterised in that each of the transport conveyors is configured and adapted for substantially horizontal transport of the containers substantially horizontally along a transport path through at least a portion of one of the stunning zones. A “substantially horizontal transport of the containers” means, for the purposes of the invention, either horizontal or almost horizontal, i.e. with a deviation of at most ±15°, particularly preferably at most ±5°. This ensures that the poultry are transported as naturally as possible. In addition, horizontal transport enables a design with a small surface, ensuring a compact construction. The transport conveyors of the transport device can be present in a single apparatus in different embodiments, however, they are at least configured and adapted to transport the containers along a transport path via at least one section of the stunning zone. Preferably, at least one of the transport conveyors is configured and adapted to transport the containers in at least two transport directions. More preferably, at least one of the transport conveyors is configured and adapted to transport the containers in four transport directions.

An expedient embodiment of the invention is characterised in that the at least one lift device is provided in the course of the stunning path between the at least two stunning zones located one above the other and having at least one transport path, in order to configure and adapt a vertical transport of the containers between at least two stunning zones, it being possible to bypass at least one of the transport paths. The bypassing makes it possible to reduce the potential stunning path, as a result of which the stunning path can be adapted, on the one hand, to the prevailing gas concentration of the stunning gas and, on the other hand, to the poultry transported in the containers, e.g. with regard to number, size, weight, species, etc. In other words, the transport paths of the at least two transport conveyors and the at least two stunning zones in conjunction with the at least one lift device are configured and adapted to each other such that the containers can be transported vertically over at least part of the stunning path in the stunning chamber, it being possible for at least one transport path of one of the transport conveyors to be bypassed. More preferably, the vertical transport allows one or a plurality of the containers containing the poultry to be transferred out. Overall, the distance to be traversed within the stunning chamber can be variably adjusted, allowing the distance to be decreased or extended.

According to a further preferred embodiment of the invention, the stunning path provided for transport of the containers can be reduced when at least one of the transport paths is bypassed by means of the lift device. This further increases the range of applications for such apparatuses, since poultry in different size compositions or numbers can thus be variably adjusted to the required stunning with the containers. In this way, the stunning path can be adjusted depending on the particular poultry in the containers, for example depending on the size, number and/or stress level of the poultry, in order to transport them through the “sweet spot” in the shortest possible time. Depending on the subsequent stunning gas concentration, this allows the poultry to be transported stunned or irreversibly unconscious through the subsequent stunning zones without causing the poultry discomfort. In this context, the “sweet spot” preferably represents a carbon dioxide concentration starting from 0% to 5% of up to 40%, as a result of which the falling asleep stage of the poultry is generally configured and adapted. Smaller poultry or a lower number of poultry per container reach the so-called “sweet spot” faster than larger poultry or a higher number of poultry per container.

A further expedient embodiment of the invention is characterised in that the lift device is configured and adapted in one of the stunning zones in such a manner that, when the containers are transported by means of the lift device, the distance of the corresponding stunning zone can be reduced. Different flocks of poultry and different sizes of poultry may be in different stages of physical agility and activity that are influenced by the environment, such as stress, discomfort, handling, climate, etc. Some flocks of poultry are very calm, while other flocks are very stressed and active. This results in a different treatment time being required for the falling asleep phase/stunning phase, which is compensated for by using one of the bypasses configured and adapted by the lift device. Such detours are also known under the concept of “bypass”. In this way, the treatment time can be reduced at a constant transport speed. In addition, some poultry flocks require a longer falling asleep phase/stunning phase. Preferably, when the containers are transported by means of the lift device, the distance of the corresponding stunning zone can be extended by feeding the containers from a lower stunning zone to an upper stunning zone again by means of the lift device. In this way, the treatment time can be extended at a constant transport speed.

A preferred development of the invention is characterised in that the transport device and/or the at least one lift device is/are adjustable to the poultry in such a manner that a variable transport speed and/or a variable stunning path can be set, depending on the number and/or weight of the poultry in the containers, in order to provide number-specific and/or weight-specific stunning of the poultry. The term “weight” also includes, in particular the size of the poultry. More preferably, a species-specific adjustability of the transport device and/or of the at least one lift device can be configured and adapted. The ability to adjust the stunning path by means of the transport device and/or the at least one lift device improves the specific stunning of the poultry present based on their actual physiognomy. As a rule, larger or heavier poultry require a higher gas concentration of the stunning gas or longer exposure to a stunning gas, so that such poultry are preferably transported more slowly by means of the transport device and/or that a longer stunning path is selected by means of the lift device. In the case of smaller or lighter poultry, it is possible in a further preferred embodiment to configure and adapt faster transport by means of the transport device and/or to configure a shortening of the stunning path, for example by bypassing at least part of a stunning path by means of the at least one lift device.

An expedient embodiment of the invention is characterised in that the stunning chamber is configured and adapted as a closed stunning tunnel and the stunning path extends substantially horizontally in a meandering manner, the at least two stunning zones being arranged one above the other in a substantially horizontal meandering manner. For this purpose, the stunning tunnel is preferably tube-shaped or serpentine, the individual stunning zones being separated from each other. The closed stunning tunnel is not limited to a round cross-section, rather rectangular diameters, for example, are also possible. The stunning tunnel represents a closed region so as to require little expansion of space in terms of length due to the meandering configuration and at the same time, due to the different stunning zones, the natural properties of stunning gases can be used during their distribution in rooms; for example, according to which heavier stunning gases are present in the lower stunning zones. Preferably, the stunning chamber of the stunning tunnel can be divided into three stunning zones with a low, medium and high concentration of stunning gas. In a further preferred embodiment, the natural density of the carbon dioxide is used to provide a lower gas concentration in higher regions of the apparatus where, for example, the input station and/or the output station is arranged. This results in a safe work environment which reduces the risk of injury.

An advantageous development is characterised in that the stunning chamber comprises a stunning compartment with the at least two stunning zones, the containers being transportable through the at least two stunning zones in each case by means of at least one of the transport conveyors substantially horizontally, and the at least one lift device being configured and adapted for vertical transport between at least two transport conveyors. This enables the containers to be transported by means of the apparatus in order to display different stunning paths and yet to configure and adapt an individual stunning path depending on the poultry transported in the containers. The stunning compartment can preferably comprise openings between the at least two stunning zones, allowing the stunning gas to pass at least partially between the adjacent stunning zones. In a further embodiment, the stunning zones can be separated from each other in such a manner that openings are only formed in the region of the lift devices, the containers being transported through these openings on the one hand, and it being possible to configure a gas exchange via them on the other hand.

In a further preferred development of the invention, the at least one input station and/or the at least one output station comprises at least one gas barrier, configured and adapted such that the gas mixture remains substantially in the stunning chamber and/or that substantially no ambient gas enters the stunning chamber. In this way, an option is provided for preventing an undesirable escape of gas from the stunning chamber or to guard against an undesirable entry of gas into the stunning chamber. The at least one gas barrier prevents potential health risks due to escaping stunning gas. The gas barrier can be configured and adapted, for example, by means of a curtain, an airlock device or by structural measures to form an airlock. Preferably, the input station and/or the output station for the containers can be closed in a simple manner with air locks or the like.

In a further advantageous embodiment of the invention, the stunning chamber comprises at least one gassing device, configured and adapted to provide a gas and/or a gas mixture in the stunning chamber. The at least one gassing device preferably provides the stunning gas in a sufficient stunning gas concentration to stun the poultry. Preferably, a plurality of gassing devices are located inside a stunning chamber which are configured and adapted to provide stunning gas and/or air or oxygen. In this way, the gas level prevailing in the stunning chamber can be adjusted at short notice by providing desired gases and/or gas mixtures. In a further preferred embodiment, the apparatus comprises a degassing device, configured and adapted to at least partially discharge the gas and/or gas mixture contained in the stunning chamber. Such degassing devices are configured and adapted, for example, as fans or suction devices.

A further expedient embodiment of the invention is characterised in that a stunning gas or a gas mixture containing a stunning gas can be provided in the lowermost of the at least two stunning zones by means of at least one of the at least one gassing devices, in order to configure and adapt a gas mixture with a first concentration of a stunning gas in the lowermost stunning zone. In a preferred embodiment, the concentration of the gas mixture in the lowermost of the stunning zones contains at least 40% of the stunning gas, particularly preferably at least 50% of the stunning gas.

An advantageous development of the invention is characterised in that oxygen and/or an oxygen-containing gas mixture can be provided in at least one of the stunning zones by means of at least one of the at least one gassing devices, in order to configure and adapt an oxygen-containing gas mixture with a concentration of a stunning gas. Due to the at least one such gassing device, it is possible to configure and adapt regulation of the concentration of the stunning gas in one of the stunning zones and/or the entire stunning chamber. If the gas concentration of the stunning gas is too high, oxygen, for example, can be added in this way to adjust the stunning gas concentration prevailing in the respective stunning zone. In this way, the content of stunning gas in the overall concentration can be reduced, for example, to provide adjustment for different poultry species or sizes, or for number per container.

A further expedient embodiment of the invention is characterised in that the stunning chamber comprises at least one gas flow device, configured and adapted to provide a gas flow of at least one gas and/or gas mixture from a first of the stunning zones into another of the stunning zones, preferably from the lowermost stunning zone into at least one of the stunning zones above. This makes it possible to actively provide a gas flow of a gas contained in the stunning chamber which in this way is distributed in at least one of the stunning zones or in the entire stunning chamber. It is important for the wellbeing of the poultry that they remain calm and without signs of stress; namely at all times during the stunning process, which usually includes a euthanasia phase with a lower concentration of stunning gas. If stress occurs during the stunning process, the poultry start to flap their wings which can cause bruising in the flesh and breaking of the wings. Any sudden and stepwise increase in the gas concentration causes the poultry to react to this change. By means of the gas flow device, a constant but gradual increase in the concentration of stunning gas, preferably in the concentration of carbon dioxide, is configured and adapted during stunning so that the poultry do not notice the increase in the gas concentration. This takes place without successive steps or intermediate partitions, for example with curtains, airlocks, etc., so as not to cause stress in the poultry. The containers are moved against the steadily increasing flow of higher gas concentration by means of the transport device without the poultry noticing this.

According to a further preferred embodiment of the invention, the gas flow device is configured and adapted to provide a stunning gas and/or a gas mixture containing a stunning gas flowing in the stunning chamber, preferably in the lowermost stunning zone, the gas concentration of the stunning gas and/or of the gas mixture containing the stunning gas decreasing gradually along the meandering stunning path, starting from a maximum gas concentration of the stunning gas. In other words, it is possible by means of the gas flow device to provide a flow of the gas mixture containing the stunning gas in the course of the meandering configuration of the stunning zones, in which the gas concentration of the stunning gas increases gradually in the course of the transport direction of the containers, starting from the input station. The containers are preferably transported against and in the direction of the higher gas concentration, as a result of which the poultry contained therein are gradually exposed to an increased gas concentration of the stunning gas, starting from a lower gas concentration. For example, the property of carbon dioxide having a higher density than oxygen or air is used to achieve the different concentrations of gas. One method consists of providing pure carbon dioxide at the lowest point of the stunning chamber and controlling the steady decrease in carbon dioxide content up to the input station by adding oxygen or ambient air at one or more points to produce, in a preferred embodiment, a CO₂ curve of 1.5% to 50% CO₂ in the first pass from the entrance up to the “sweet spot” of unconsciousness (up to 40%). Following this, a higher concentration of gas can be provided as necessary to induce irreversible unconsciousness in the poultry.

A preferred development of the invention is characterised in that the gas flow of a gas and/or a gas mixture is flowable through the stunning tunnel along the meandering stunning path via at least one lift device from the lowermost stunning zone into at least one of the stunning zones above. The gas and/or gas mixture can thus be transported through a plurality of stunning zones over the course of the entire stunning chamber. For this purpose, the at least one lift device can preferably have at least one opening which is configured and adapted for passing a gas and/or a gas mixture at least as when necessary. Such openings are more preferably configured and adapted to be sealable.

According to a further preferred embodiment, the apparatus comprises a control unit and/or a regulation unit by means of which the transport speed of the or each transport conveyor, the use of the at least one lift device and the composition of the gas mixture with regard to the concentration of the stunning gas in the gas mixture can be controlled and/or regulated in at least one of the stunning zones. For this purpose, the control and/or regulation unit preferably comprises at least one computer unit to configure and adapt the control and/or regulation operations. The control and/or regulation unit is more preferably configured and adapted to execute the control and/or regulation based on empirical data and/or provided information; for example, based on the gas concentration or composition within the stunning zones. The number, size and/or species of the poultry transported in the containers is preferably taken into account for control and/or regulation. In addition, the control and/or regulation can be carried out based on the concentration of the stunning gas prevailing in the stunning chamber or in the stunning zones. More preferably, the control and/or regulation unit is configured and adapted in such a manner that the corresponding operations, i.e. an adjustment of the stunning path, the transport speed and/or the stunning gas concentration, are carried out automatically. In a preferred embodiment, the gassing device and/or the gas flow device is/are also configured and adapted to be controllable and/or regulatable by means of the control and/or regulation unit. The apparatus according to the invention or the control and/or regulation unit is preferably configured and adapted in such a manner that it comprises a programmable logic controller (PLC). PLC control systems are configured and adapted in particular to control various interdependent parameters so that, for example, the speed of the transport device (transport conveyor), the number of poultry in each container, the speed of subsequent processes (e.g. slaughter line), the effective stunning time, the gas concentration in each stunning zone, monitoring in the stunning zones with alarm or the like and, in particular, the change in the stunning path can be controlled and/or regulated. The change in the stunning path is achieved by bypassing at least one transport path, which can be controlled and/or regulated by switching the corresponding lift devices in or out, i.e. whether, for example, a long “falling asleep phase” and a short period of high gas concentration is required. The control and/or regulation unit is preferably configured and adapted in such a manner that adjustment of the parameters referred to above takes place automatically, for example, the settings change accordingly, e.g. when the poultry are larger, which means that there are fewer poultry in the containers and on the transport conveyors but the speed of subsequent processes (e.g. slaughter line) remains the same, making it necessary to increase the number of poultry conveyed through the stunning chamber per minute, i.e. to increase the transport speed and extend the stunning path. All information and parameters are monitored by the PLC or the control and/or regulation unit which is configured and adapted, for example, as a computer (system), and the settings are preferably immediately controllable and/or regulatable during operation with corresponding poultry in the containers, more preferably automatically.

A development is characterised in that the or each input station is configured and adapted for vertically and/or horizontally feeding the containers onto the at least one transport path. Depending on the conditions at the production site, feeding in can take place in a vertical direction, preferably from above, for example by means of a lift device, and/or in a horizontal direction from the side, for example with a transverse conveyor to guide the containers into the stunning chamber. This creates a compact apparatus. The same also applies, incidentally, to the or each output station. More preferably, when feeding from the horizontal side, the opening is configured and adapted to be smaller so that there is as little gas exchange as possible between the gas of the stunning chamber and the ambient air.

A preferred development of the invention is characterised in that the or each output station is configured and adapted for vertically and/or horizontally discharging the containers from the stunning chamber.

An expedient embodiment of the invention is characterised in that a lift device is provided at the beginning and/or at the end of the transport path of each transport conveyor, in order to configure and adapt a vertical transport of the containers.

The object is also achieved by a method referred to hereinbefore, comprising the steps: feeding the containers containing the live poultry into a stunning chamber by means of at least one input station, the at least one stunning chamber being arranged above ground; transporting the containers through at least two stunning zones of the stunning chamber that lie substantially horizontally one above the other by means of a transport device with at least one transport conveyor, the gas mixture of the at least two stunning zones having different concentrations of the stunning gas in each case, the concentration of the stunning gas in the gas mixture of the at least two stunning zones increasing, starting from the uppermost of the stunning zones to the lowermost of the stunning zones; discharging of the containers containing the stunned poultry by means of an output station, the containers being transported on the at least one transport path substantially horizontally in a meandering manner through the at least two stunning zones along a stunning path in the stunning chamber.

To avoid repetition, reference is made in connection with the method according to the invention to the merits already described in detail in connection with the apparatus according to the invention. They also apply by analogy to the method according to the invention given below.

A development is characterised in that the containers are transported substantially vertically, at least in sections, by means of at least one lift device comprising the transport device, the input station and/or the output station.

An expedient embodiment of the invention is characterised in that the containers are transported on the stunning path substantially horizontally in a meandering manner, the at least two stunning zones being arranged substantially horizontal one above the other in a meandering manner.

A further expedient embodiment of the invention is characterised in that the containers are transported substantially horizontally through the at least two stunning zones, each by means of at least one of the transport conveyors, the at least one lift device transporting the containers substantially vertically between at least two transport conveyors.

A development is characterised in that, in the course of the stunning path, the containers are transported by the at least one lift device between at least two of the stunning zones located one above the other and having at least one transport path, in order to configure and adapt a vertical transport of the containers between at least two stunning zones, wherein at least one of the transport paths is bypassed.

In an advantageous embodiment of the invention, bypassing the containers of at least one of the transport paths reduces the stunning path provided for transporting the containers.

A further expedient embodiment of the invention is characterised in that a gas and/or a gas mixture is provided in the stunning chamber by means of at least one gassing device.

In a further advantageous embodiment of the invention, a gas mixture with a first concentration of a stunning gas is provided in the lowermost of the at least two stunning zones by means of the at least one gassing device.

According to a further preferred embodiment of the invention, in at least one of the stunning zones, preferably in the lowermost of the stunning zones, oxygen and/or an oxygen-containing gas mixture is provided by means of the at least one gassing device, in order to configure and adapt an oxygen-containing gas mixture with a concentration of a stunning gas.

An expedient embodiment of the invention is characterised in that a gas flow of at least one gas and/or gas mixture from a first stunning zone into another stunning zone is provided in the stunning chamber by means of at least one gas flow device, preferably from the lowermost stunning zone into at least one of the stunning zones above.

A further expedient embodiment of the invention is characterised in that the containers each pass through at least three stunning zones one after the other along the stunning path in a substantially horizontal direction, namely a first phase I with a concentration of 5-25% stunning gas in the gas mixture, a second phase II with a concentration of 25-50% stunning gas in the gas mixture and a third phase III with a concentration of 50-100% stunning gas in the gas mixture. These stunning zones each relate to the stunning zones adjacent to each other. Thus, for example, it is possible to pass through the provided gas mixture of a first stunning zone with a concentration of e.g. 5-25% stunning gas in the gas mixture (phase I) independently of the gas mixture of a second stunning zone with a concentration of 25-50% stunning gas in the gas mixture (phase II) and this in turn independently of the gas mixture of a third stunning zone with a concentration of 50-100% stunning gas in the gas mixture (phase III). The concentration of the stunning gas is preferably substantially constant within a stunning zone. Expediently, all containers each pass through at least three stunning zones one after the other in transport direction T, namely a first phase I with a concentration of 5-25% stunning gas in the gas mixture, a second phase II with a concentration of 25-50% stunning gas in the gas mixture and a third phase III with a concentration of 50-100% stunning gas in the gas mixture. However, the number of phases and their concentration ranges can, of course, vary.

A preferred embodiment is characterised in that downstream of the stunning zones with phases I to III, possible fluctuations in the concentration of stunning gas in the gas mixture are compensated by increasing or reducing the concentration of stunning gas in the gas mixture.

A preferred development of the invention is characterised in that in the stunning zones with phases I to III, possible fluctuations in the concentration of stunning gas in the gas mixture are compensated by increasing or reducing the concentration of stunning gas in the gas mixture, preferably by feeding in at least one gas and/or gas mixture using the at least one gassing device. In this way, it is possible, on the one hand, to actively respond to an incorrect gas concentration of the stunning gas in order to create ideal conditions for stunning the poultry and, on the other hand, the concentration of the stunning gas can be actively adjusted during transport if changes become necessary during the stunning process.

According to a further preferred embodiment, the gas concentration of the stunning gas in the gas mixture is monitored in at least one of the at least two stunning zones. Monitoring is preferably performed by means of a gas monitoring device comprising the apparatus, which comprises at least one sensor, for example. In a further preferred embodiment, the apparatus comprises at least one monitoring system, preferably a camera monitoring system, to monitor the stage and point of unconsciousness of the poultry. For this purpose, monitoring of the stunning chamber is configured and adapted in particular by means of the camera monitoring system and/or through viewing windows. The gas concentration present, for example the carbon dioxide content of up to 40%, is monitored by means of the gas monitoring device (e.g. sensors), it being possible to re-position, shorten or extend the stunning path or stunning time from entry up to the “sweet spot” of unconsciousness (up to 40%) as necessary.

### BRIEF DESCRIPTION OF THE DRAWINGS

Further expedient and/or advantageous features and developments of the apparatuses according to the invention as well as preferred method steps emerge from the description. Particularly preferred embodiments of the invention are explained in greater detail with reference to the attached drawing. The drawings show:

FIG. 1 is a schematic diagram of a preferred embodiment of the apparatus according to the invention in a lateral view;

FIG. 2 is a schematic diagram of a preferred embodiment of the apparatus according to the invention in a view from above; and

FIG. 3 is a schematic diagram of a further preferred embodiment of the apparatus according to the invention in a lateral view.

### DETAILED DESCRIPTION OF THE INVENTION

The apparatus 10 according to the invention will be explained in greater detail with reference to the aforementioned figures. The apparatus 10 shown in the drawings is used for gas-stunning poultry, namely broiler chickens, which are transported through a stunning chamber 12 arranged in individual containers 11. However, the apparatus 10 according to the invention is also used in the same way for stunning poultry which are transported through the stunning chamber 12 in stacks of containers, that is in two or more containers arranged one above the other. Naturally, the apparatus 10 is also suitable for stunning other species of poultry, such as geese, ducks or the like.

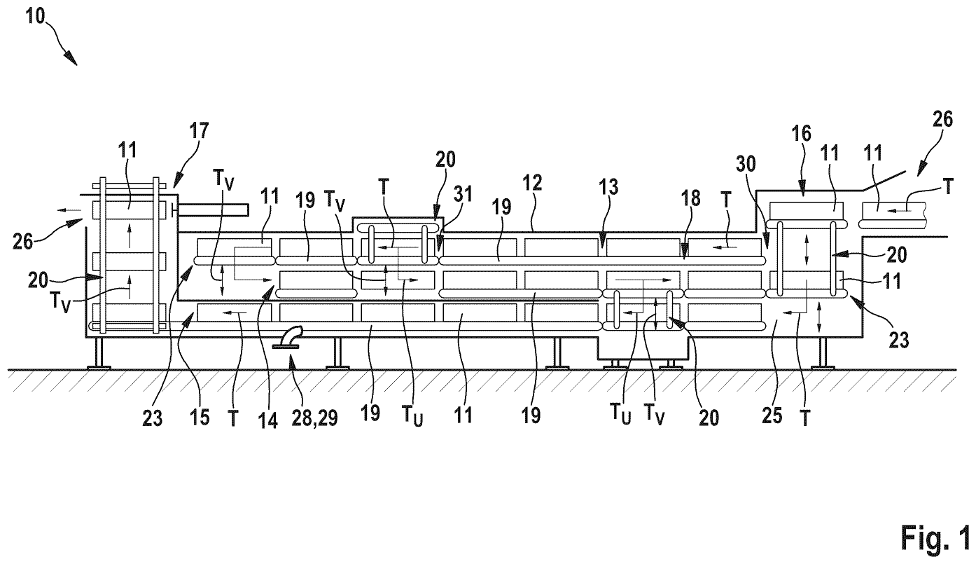

FIG. 1 to FIG. 3 each show an apparatus 10 for gas-stunning live poultry, which are intended for slaughter and are located in containers 11, by means of a gas mixture containing a stunning gas. The apparatus 10 comprises at least one stunning chamber 12 having at least two stunning zones 13, 14, 15, at least one input station 16, arranged on the inlet side of the stunning chamber 12, for the containers 11 containing live poultry and at least one output station 17, arranged on the outlet side of the stunning chamber 12, for the containers 11 containing stunned poultry, a transport device 18 with at least one transport conveyor 19 configured and adapted for transporting the containers 11 from the input station 16 to the output station 17 through the stunning chamber 12 along at least one transport path.

This apparatus 10 is characterised according to the invention in that the at least one stunning chamber 12 is arranged above ground and the at least two stunning zones 13, 14, 15 are configured and adapted to lie substantially horizontally one above the other, and in that the gas mixture of the at least two stunning zones 13, 14, 15 has different concentrations of the stunning gas in each case, the concentration of the stunning gas in the gas mixture of the at least two stunning zones 13, 14, 15 increasing, starting from the uppermost of the stunning zones 13 to the lowermost of the stunning zones 15, and in that the transport device 18 is configured and adapted in such a manner that the containers 11 can be transported on the at least one transport path substantially horizontally in a meandering manner through the at least two stunning zones 13, 14, 15 along a stunning path in the stunning chamber 12. FIG. 1 shows transport of the containers 11, configured and adapted by means of the transport device 18, in greater detail using arrow symbols to illustrate preferred transport directions T of the containers 11 as they pass along the stunning path.

When taken on their own or in combination with each other, the features and developments described below illustrate preferred embodiments. It is expressly pointed out that features which are summarised in the description or are described in a common embodiment can also further develop the apparatus 10 described above in a functionally independent manner. The same applies to the further embodiments and the method described below.

The embodiment of the apparatus 10 shown in FIG. 1 has a total of three stunning zones 13, 14 and 15. However, the number of stunning zones 13, 14, 15 can vary but at least two stunning zones are provided in order to provide the required different concentrations of stunning gas for stunning the poultry. In a further preferred embodiment, not shown in the figures, the stunning chamber 12 of the apparatus 10 can comprise up to five stunning zones.

Preferably, the transport device 18 comprises a plurality of transport conveyors 19, the number of transport conveyors 19 corresponding at least to the number of stunning zones 13, 14, 15 provided. In the apparatus 10 of FIG. 1, a transport device 18 with a plurality of transport conveyors 19, which can be driven and controlled together or preferably separately, are provided for transporting the containers 11 through the stunning chamber 12. In the event that a plurality of transport conveyors 19 are arranged one behind the other, they can be operated in coordination with each other. The or each transport conveyor 19 is preferably configured and adapted for substantially horizontal transport of the containers 11 along a transport path through at least a portion of one of the stunning zones 13, 14, 15. The stunning chamber 12 in the embodiment of FIG. 1 is a chamber with an open space but is preferably closed on all sides and sealed with respect to the environment.

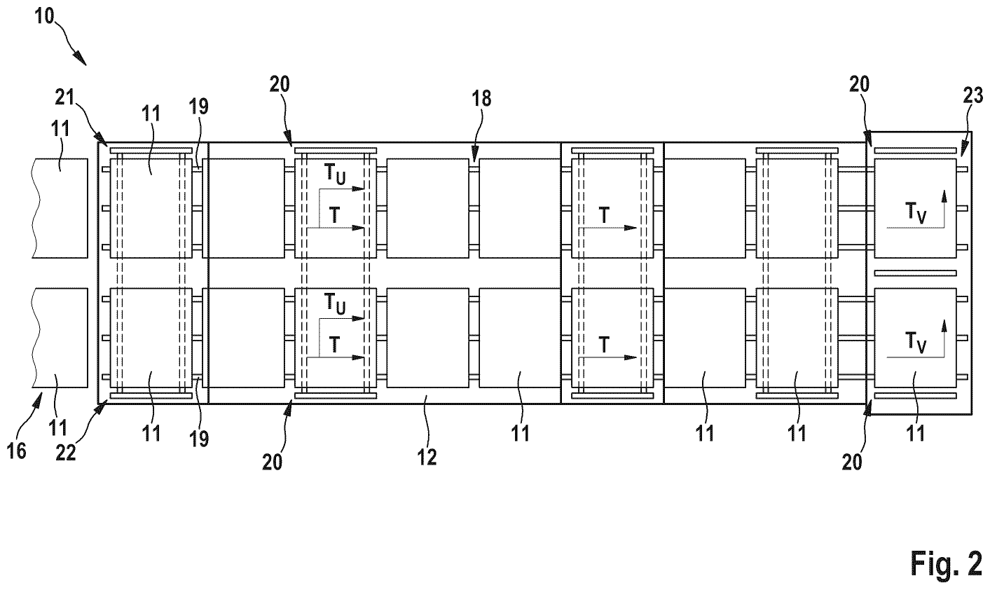

In the preferred embodiment of FIG. 2, which shows a view from above of the apparatus 10 according to the invention, a stunning chamber 12 is shown with a transport device 18 for transporting containers 11 arranged in two rows 21, 22. Basically, the invention encompasses embodiments that can transport more than one container 11 widthways. The required components of the apparatus, such as the transport conveyors 19, lift devices 20, etc., can be adapted accordingly to the width of a plurality of containers 11. The two rows 21, 22 shown in FIG. 2 for transporting the containers 11 can be controllable either in parallel or independently.

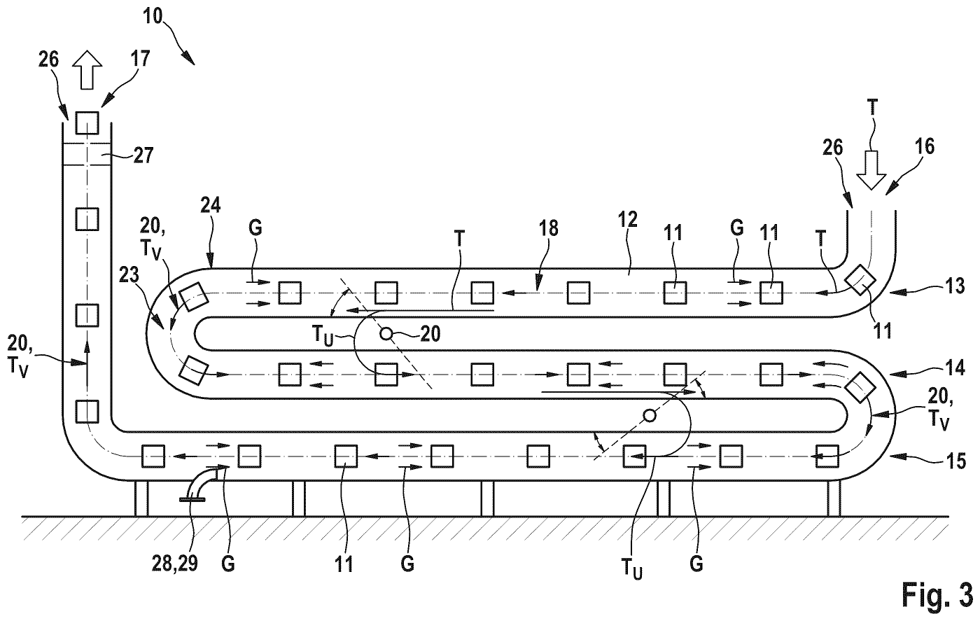

The transport device 18, the input station 16 and/or the output station 17 preferably comprises/comprise at least one lift device 20 for transporting the containers 11 substantially vertically. In the embodiment of FIG. 1 and FIG. 3, a plurality of lift devices 20 are provided which each configure and adapt a vertical transport T_{V} of the containers 11. Both the input station 16 and the output station 17 each comprise a lift device 20 whereby the containers 11 are preferably inserted into or discharged from the stunning chamber 12 from a level above the uppermost stunning zone 13. Preferably, a gas mixture with a low or non-existent concentration of a stunning gas, i.e. less than 10%, is present in the region above the uppermost stunning zone 13. In the embodiment of FIG. 1, the transport device 18 comprises at least three lift devices 20, whereby a vertical transport T_{V} of the containers 11 within the stunning chamber 12 is configured and adapted in each case. For example, a lift device 20 is located at the ends 23 of the uppermost and the middle stunning zone 13, 14 to configure and adapt transfer of the containers 11 from the one stunning zone 13 to the further stunning zone 14. By means of the lift device 20, the containers 11 can each be individually lowered or raised so that the containers 11 can be assigned, for example, to a corresponding stunning zone 13, 14, 15 depending on the specification. The lift device 20 preferably comprises a transport conveyor 19 or means for transporting the containers 11 in order to configure and adapt further transport of the containers 11, after vertical transport T_{V}, onto a transport conveyor 19 adjoining the lift device 20.

Preferably, the or each input station 16 is configured and adapted for vertically and/or horizontally feeding the containers 11 onto the at least one transport path. More preferably, the or each output station 17 is configured and adapted for vertically and/or horizontally discharging the containers 11 from the stunning chamber 12.

As shown in FIG. 1 and FIG. 2, the stunning chamber 12 preferably comprises a stunning compartment 25 with the at least two stunning zones 13, 14, 15, the containers 11 being transportable through the at least two stunning zones 13, 14, 15 in each case by means of at least one of the transport conveyors 19 substantially horizontally, and the at least one lift device 20 being configured and adapted for vertical transport T_{V} between at least two transport conveyors 19.

Preferably, the at least one lift device 20 is provided in the course of the stunning path between the at least two stunning zones 13, 14, 15 located one above the other and having at least one transport path, in order to configure and adapt a vertical transport T_{V} of the containers 11 between at least two stunning zones 13, 14, 15, it being possible to bypass at least one of the transport paths. Preferably, the lift device 20 is configured and adapted in one of the stunning zones 13, 14, 15 in such a manner that, during a transport T_{V} the containers 11 by means of the lift device 20, the distance of the corresponding stunning zone 13, 14, 15 can be reduced. Bypassing during transport T_{U} of the containers 11 is configured and adapted by means of the vertical transport T_{V} of the lift device 20, whereby the containers 11 are preferably not transported over the entire potential path of one of the stunning zones 13, 14, 15. More preferably, the stunning path provided for transport of the containers 11 can be reduced when at least one of the transport paths is bypassed by means of the lift device 20. In this way, at a constant transport speed, the poultry are exposed to the gas concentration of the stunning gas prevailing in the stunning zones 13, 14, 15 for a shorter period of time.

The transport device 18 and/or the at least one lift device 20 is/are preferably adjustable to the poultry in such a manner that a variable transport speed and/or a variable stunning path can be set, depending on the number and/or weight of the poultry in the containers 11, in order to provide number-specific and/or weight-specific stunning of the poultry. A variable stunning path can be configured, for example by changing the length of the stunning path, in that at least one of the lift devices 20 can configure and adapt a vertical transport T_{V} of the containers 11, whereby a transport T_{U} of the containers 11 takes place along the reduced stunning path when at least one of the transport paths is bypassed. Due to the preferably configured bypass transport direction T_{U} of the containers 11 by means of at least one of the lift devices 20, as illustrated by means of the arrow symbols in FIG. 1, FIG. 2 and FIG. 3, the length of the transport path or stunning path can be variably adapted depending on the size or number of the poultry to be fed in. Containers 11 with large poultry or a high number of poultry, for example, can each be transported along the entire length of the stunning zones 13, 14, 15 and, at the end of the stunning zones 13, 14, can be transported into the stunning zones 14, 15 located below by means of the lift devices 20 to configure a stunning path that is as long as possible. Optionally, it is additionally possible to pass through at least one of the stunning zones 13, 14 again by transporting the containers into a stunning zone 13, 14 located above by means of the lift device 20. Containers 11 with poultry of medium size can be transported, by means of one of the lift devices 20, arranged between two transport conveyors 19 in the course of the stunning zones 13, 14, 15, into stunning zones 14, 15 located below before the end 23 of the respective stunning zone. Containers 11 with small poultry can either be transported directly into a lower lying stunning zone 14, 15 by means of the input station 16 or can bypass a plurality of transport paths by means of the lift devices 20. The number of the lift devices 20 and their positions can vary. Overall, the number of the stunning zones 13, 14, 15 can be reduced or increased based on the poultry transported in the containers 11.

In the further embodiment of the apparatus 10 according to the invention shown in FIG. 3, the stunning chamber 12 is preferably configured as a closed stunning tunnel 24. In FIG. 3, the stunning path also runs substantially horizontally in a meandering manner, the at least two stunning zones 13, 14, 15 being arranged substantially horizontal one above the other in a meandering manner. The transport device 18 with the or each transport conveyor 19 forming a transport path is configured and adapted along the stunning path for substantially horizontal transport of the containers 11 in a meandering manner through the entire apparatus 10 and correspondingly also from stunning zone 13 to stunning zone 15. The stunning tunnel 24 is preferably closed on all sides (with the exception of the openings 26 for feeding in and discharging the containers 11, i.e. at the input station 16 and at the output station 17). Optionally, the stunning tunnel can also be sealed with respect to the environment using means, not shown in detail in FIG. 3, in the form of visible or invisible airlocks or the like. Such means for sealing can also be present between the individual stunning zones 13, 14, 15. In addition, such a stunning tunnel 24 preferably comprises at least one lift device 20 which configures and adapts a transport of the containers 11 vertically T_{V}. The at least one lift device 20 is preferably located at the end 23 of a stunning zone 13, 14, 15. Furthermore, such an apparatus 10 preferably comprises at least one lift device 20 between at least two stunning zones 13, 14, 15 in order to provide a bypass T_{U} of at least one transport path, thereby shortening the stunning path for the containers 11 containing poultry. The operating principle of the variable stunning path in the embodiment of FIG. 3 is configured and adapted similarly to FIG. 1 and FIG. 2, so that reference is made to the above paragraphs. In addition, sealable airlocks, flaps or the like, not shown in detail in the Figure, are provided in the present stunning tunnel 24, preferably in the region of the lift device 20, in order to configure and adapt an opening between the stunning zones 13, 14, 15 for transporting the containers 11 when at least one transport path along the processing path is bypassed T_{U}.

Preferably, the at least one input station and/or the at least one output station 16, 17 comprises at least one gas barrier 27, configured and adapted such that the gas mixture remains substantially in the stunning chamber 12 and/or that substantially no ambient gas enters the stunning chamber 12. The gas barrier 27 can be configured and adapted, for example, by means of a curtain, an airlock device or by structural measures to form an airlock. More preferably, the at least one input and/or the at least one output station 16, 17 is arranged above the stunning chamber 12 or above the uppermost stunning zone 13, respectively, to configure secure and simple sealing of the stunning chamber 12 with respect to the environment. Particularly preferably, the gas concentration of the stunning gas at the inlet and outlet, i.e. in the region of the at least one inlet and/or the at least one output station 16, 17, is close to zero (maximum 10%).

Optionally, the stunning chamber 12 comprises at least one gassing device 28, configured and adapted to provide a gas and/or a gas mixture in the stunning chamber 12. Preferably, a stunning gas or a gas mixture containing a stunning gas can be provided in the lowermost 15 of the at least two stunning zones 13, 14, 15 by means of at least one of the at least one gassing devices 28, in order to configure and adapt a gas mixture with a first concentration of a stunning gas in the lowermost stunning zone 15. Alternatively or additionally, oxygen and/or an oxygen-containing gas mixture can be provided in at least one of the stunning zones 13, 14, 15 by means of at least one of the at least one gassing devices 28, in order to configure and adapt an oxygen-containing gas mixture with a concentration of a stunning gas.

Preferably, the stunning chamber 12 comprises at least one gas flow device 29, configured and adapted to provide a gas flow G of at least one gas and/or gas mixture from a first of the stunning zones 13, 14, 15 into another of the stunning zones 13, 14, 15, preferably from the lowermost stunning zone 15 into at least one of the stunning zones 14, 13 above. Particularly preferably, the gas flow device 29 is configured and adapted to provide a stunning gas and/or a gas mixture containing stunning gas flowing in the stunning chamber 12, preferably in the lowermost stunning zone 15, the gas concentration of the stunning gas and/or of the gas mixture containing the stunning gas decreasing gradually along the meandering stunning path, starting from a maximum gas concentration of the stunning gas. More preferably, the gas flow G of a gas and/or a gas mixture is flowable through the stunning tunnel 24 along the meandering stunning path via at least one lift device 20 from the lowermost stunning zone 15 into at least one of the stunning zones 14, 13 above. In FIG. 3, the gas flow G is shown schematically by means of arrow symbols pointing contrary to the stunning path and contrary to the transport direction T of the containers 11. Preferably, the intensity of the gas flow G decreases gradually, starting from the gas flow device 29, it being possible to have a plurality of gas flow devices 29 arranged inside the stunning chamber 12 in order to maintain a desired flow rate over the entire course of the stunning zones 13, 14, 15. The gas flow device 29, for example, is a continuous-flow machine, particularly preferably a fan.

Optionally, at least one means, not explicitly shown in the figures, is assigned in the stunning chamber 12 for determining the gas concentration of the stunning gas in the gas mixture inside the stunning zones 13, 14, 15, for detecting the flow rate of a gas flow G and/or for visually monitoring the stunning zones 13, 14, 15. This means can comprise gas sensors and/or a camera and/or other detection components that provide relevant information in connection with the stunning process in one of the stunning zones 13, 14, 15.

Particularly preferably, the apparatus 10 comprises a control and/or regulation unit, not shown in detail in the figures, by means of which the transport speed of the or each transport conveyor 19, the use of the at least one lift device 20 and the composition of the gas mixture with regard to the concentration of the stunning gas in the gas mixture can be controlled and/or regulated in at least one of the stunning zones 13, 14, 15. More preferably, the control and/or regulation unit can also be used to control/regulate the further components of the apparatus 10, such as the or each input station 16, the or each output station 17 and/or the or each lift device 20 and the gassing device 28 and/or the gas flow device 29. Preferably, all components of the apparatus can be controlled and/or regulated separately and independently of each other. However, the higher-level control and/or regulation unit is used to ensure coordinated and continuous functioning of the apparatus 10, in particular taking into account the poultry transported in the containers 11.

In preferred embodiments, a lift device 20 is provided at the beginning 30 and/or at the end 31 of the transport path of each transport conveyor 19, in order to configure and adapt a vertical transport T_{V} of the containers 11. In FIG. 1, an example of a transport conveyor 19 has its beginning 30 and end 31 marked with reference numerals. Upstream and downstream of the transport conveyor 19 respectively, a lift device 20 is arranged in each case which is configured and adapted for vertical transport T_{V} of the containers 11, whereby, for example, bypassing T_{U} of the subsequent transport path of the adjoining transport conveyor 19 exists.

The method is explained in greater detail below with reference to the drawing: The method is used for gas-stunning live poultry, which are intended for slaughter and are located in containers 11, by means of a gas mixture containing a stunning gas. For this purpose, the containers 11 containing the live poultry are fed into a stunning chamber 12 by means of at least one input station 16, the stunning chamber 12 being arranged above ground. Subsequently, the containers 11 are transported by means of a transport device 18 with at least one transport conveyor 19 through at least two stunning zones 13, 14, 15, arranged substantially horizontally one above the other, of the stunning chamber 12, the gas mixture of the at least two stunning zones 13, 14, 15 having different concentrations of the stunning gas in each case, the concentration of the stunning gas in the gas mixture of the at least two stunning zones 13, 14, 15 increasing, starting from the uppermost of the stunning zones 13 to the lowermost of the stunning zones 15. Finally, the containers 11 containing the stunned poultry are discharged by means of an output station 17.

This method is characterised according to the invention in that the containers 11 are transported by means of the transport device 18 on the at least one transport path through the at least two stunning zones 13, 14, 15 in a substantially horizontally meandering manner along a stunning path into the stunning chamber 12.

Preferably, the containers 11 are transported substantially vertically T_{V}, at least in sections, by means of at least one lift device 20 comprising the transport device 18, the input station 16 and/or the output station 17. In FIGS. 1 to 3, a plurality of lift devices 20 are provided in each case to transport the containers 11, for example vertically T_{V} between the stunning zones 13, 14, 15. More preferably, the containers 11 are transported on the stunning path substantially horizontally in a meandering manner, the at least two stunning zones 13, 14, 15 being arranged substantially horizontal one above the other in a meandering manner.

In the embodiments shown by way of example, the containers 11 are transported substantially horizontally through the at least two stunning zones 13, 14, 15, each by means of at least one of the transport conveyors 19, the at least one lift device 20 transporting the containers 11 substantially vertically between at least two transport conveyors 19. Preferably, in the course of the stunning path, the containers 11 are thereby transported by the at least one lift device 20 between at least two of the stunning zones 13, 14, 15 located one above the other and having at least one transport path, in order to configure and adapt a vertical transport T_{V} of the containers 11 between at least two stunning zones 13, 14, 15, at least one of the transport paths being bypassed T_{U}. Particularly preferably, bypassing T_{U} the containers 11 of at least one of the transport paths reduces the stunning path provided for transport of the containers 11. In other words, when bypassing T_{U} at least one transport path, the stunning path potentially available is reduced by the transport path bypassed, whereby the poultry transported in the containers 11 are exposed for a shorter period of time in the corresponding stunning zone 13, 14, 15 (at least at a constant transport speed).

Preferably, a gas and/or a gas mixture is provided in the stunning chamber 12 by means of at least one gassing device 28. The gas and/or gas mixture can more preferably be introduced by mechanical ventilation. The gas and/or gas mixture introduced can be controlled and/or regulated as required. Particularly preferably, a gas mixture with a first concentration of a stunning gas is provided in the lowermost 15 of the at least two stunning zones 13, 14, 15 by means of the at least one gassing device 28. Additionally and/or alternatively, in at least one of the stunning zones 13, 14, 15, preferably in the lowermost of the stunning zones 15, oxygen and/or an oxygen-containing gas mixture is provided by means of the at least one gassing device 28, in order to configure and adapt an oxygen-containing gas mixture with a concentration of a stunning gas.

Optionally, in the stunning chamber 12, a gas flow G of at least one gas and/or a gas mixture is provided from a first stunning zone 13, 14, 15 to another stunning zone 13, 14, 15 by means of at least one gas flow device 29, preferably from the lowermost stunning zone 15 to at least one of the stunning zones 14, 13 above.

In the embodiments shown by way of example in FIG. 1 to FIG. 3, the containers 11 each pass through at least three stunning zones 13, 14, 15 one after the other along the stunning path in a substantially horizontal direction, namely a first phase I with a concentration of 5-25% stunning gas in the gas mixture, a second phase II with a concentration of 25-50% stunning gas in the gas mixture and a third phase III with a concentration of 50-100% stunning gas in the gas mixture. Particularly preferably, a concentration of approx. 10% stunning gas in the gas mixture is selected in phase I, a concentration of approx. 40% stunning gas in the gas mixture is selected in phase II and a concentration of approx. 60% stunning in the gas mixture is selected in phase III (for deep unconsciousness, i.e. stunned) and respectively 100% stunning gas in the gas mixture (for irreversible unconsciousness, brain death, i.e. killed). The gas concentrations can vary as well as the number of phases. Possible fluctuations in the preset values for the concentration of stunning gas in the gas mixture can be compensated by increasing or reducing the concentration of stunning gas in the gas mixture, preferably by feeding in at least one gas and/or gas mixture using the at least one gassing device 28. By varying the stunning path, the corresponding times of the containers 11 in the respective stunning zones 13, 14, 15 can be adjusted depending on the poultry transported therein, so that, for example, larger poultry (or a higher number of poultry per container 11) pass through a longer stunning path than smaller poultry (or a lower number of poultry per container 11). In addition, the stunning distance can be adjusted to the stress resistance of the poultry, so that poultry that require a longer concentration of a stunning gas to achieve the desired conditions (stunned, killed, etc.) will pass through a longer stunning path than poultry that require a lower exposure to a stunning gas.

Preferably, the gas concentration of the stunning gas in the gas mixture is monitored in at least one of the at least two stunning zones 13, 14, 15. Monitoring can also include recording of the information. The information can be used, for example, to control and/or regulate the gas concentration, the transport device 18 or the lift device 20 as well as other parameters influencing the stunning process (e.g. transport speed).

1-34. (canceled)

35. An apparatus configured and adapted for gas-stunning live poultry, which are intended for slaughter and located in containers, by a gas mixture containing a stunning gas, the apparatus comprising:
at least one stunning chamber having:
at least two stunning zones;
at least one input station arranged on an inlet side of the stunning chamber for the containers containing live poultry; and
at least one output station arranged on an outlet side of the stunning chamber for the containers containing stunned poultry;
a transport device with at least one transport conveyor configured and adapted for transporting the containers from the input station to the output station through the stunning chamber along at least one transport path;
wherein;
the at least one stunning chamber is arranged above ground and the at least two stunning zones are configured and adapted to lie substantially horizontally one above the other;
the gas mixture of the at least two stunning zones has different concentrations of the stunning gas in each of the stunning zones, the concentration of the stunning gas in the gas mixture of the at least two stunning zones increasing from an uppermost of the stunning zones to a lowermost of the stunning zones; and
the transport device is configured and adapted to transport the containers on the at least one transport path substantially horizontally in a meandering manner through the at least two stunning zones along a stunning path in the stunning chamber.

36. The apparatus according to claim 35, wherein the transport device, the input station and/or the output station comprises at least one lift device for transporting the containers substantially vertically.

37. The apparatus according to claim 35, wherein the at least one transport conveyor of the transport device comprises a plurality of transport conveyors, wherein a number of transport conveyors corresponds at least to the number of stunning zones provided.

38. The apparatus according to claim 36, wherein each of the at least one transport conveyor is configured and adapted for substantially horizontal transport of the containers along a transport path through at least a portion of one of the stunning zones.

39. The apparatus according to claim 36, wherein the at least one lift device is provided in a course of the stunning path between the at least two stunning zones located one above the other and having at least one transport path, in order to configure and adapt a vertical transport of the containers between at least two of the stunning zones, wherein at least one of the transport paths can be bypassed.

40. The apparatus according to claim 39, wherein the stunning path provided for transport of the containers can be reduced when at least one of the transport paths is bypassed by the lift device.

41. The apparatus according to claim 36, wherein the lift device is configured and adapted in one of the stunning zones in such a manner that, when the containers are transported by means of the lift device, a distance of the corresponding stunning zone can be reduced.

42. The apparatus according to claim 36, wherein the transport device and/or the at least one lift device is/are adjustable to the poultry in such a manner that a variable transport speed and/or a variable stunning path can be set, depending on a number and/or weight of the poultry in the containers, in order to provide number-specific and/or weight-specific stunning of the poultry.

43. The apparatus according to claim 35, wherein the stunning chamber is configured and adapted as a closed stunning tunnel and the stunning path extends substantially horizontally in a meandering manner, wherein the at least two stunning zones are arranged one above the other in a substantially horizontal meandering manner.

44. The apparatus according to claim 36, wherein:
the stunning chamber comprises a stunning compartment with the at least two stunning zones;
the containers are transportable through the at least two stunning zones in each case by at least one of the at least one transport conveyor substantially horizontally; and
the at least one lift device is configured and adapted for vertical transport between at least two of the at least one transport conveyors.

45. The apparatus according to claim 35, wherein the at least one input station and/or the at least one output station comprises at least one gas barrier configured and adapted such that the gas mixture remains substantially in the stunning chamber and/or that substantially no ambient gas enters the stunning chamber.

46. The apparatus according to claim 35, wherein the stunning chamber further comprises at least one gassing device, configured and adapted to provide a gas and/or a gas mixture in the stunning chamber.

47. The apparatus according to claim 46, wherein a stunning gas or a gas mixture containing a stunning gas can be provided in the lowermost of the at least two stunning zones by at least one of the at least one gassing devices, in order to configure and adapt a gas mixture with a first concentration of a stunning gas in the lowermost stunning zone.

48. The apparatus according to claim 46, wherein oxygen and/or an oxygen-containing gas mixture can be provided in at least one of the stunning zones by at least one of the at least one gassing devices, in order to configure and adapt an oxygen-containing gas mixture with a concentration of a stunning gas.

49. The apparatus according to claim 35, wherein the stunning chamber further comprises at least one gas flow device, configured and adapted to provide a gas flow of at least one gas and/or gas mixture from a first of the stunning zones into another of the stunning zones. preferably from the lowermost stunning zone into at least one of the stunning zones above.

50. The apparatus according to claim 49, wherein the gas flow device is configured and adapted to provide a stunning gas and/or a gas mixture containing stunning gas flowing in the stunning chamber, preferably in the lowermost stunning zone, wherein a gas concentration of the stunning gas and/or of the gas mixture containing the stunning gas decreases gradually along the meandering stunning path, starting from a maximum gas concentration of the stunning gas.

51. The apparatus according to claim 49, wherein the gas flow of a gas and/or a gas mixture is flowable through the stunning tunnel along the meandering stunning path via at least one lift device from the lowermost stunning zone into at least one of the stunning zones above the lowermost stunning zone.

52. The apparatus according to claim 36, further comprising a control unit and/or a regulation unit by which a transport speed of the or each transport conveyor, the use of the at least one lift device and a composition of the gas mixture with regard to the concentration of the stunning gas in the gas mixture can be controlled and/or regulated in at least one of the stunning zones.

53. The apparatus according to claim 35, wherein the or each input station is configured and adapted for vertically and/or horizontally feeding the containers onto the at least one transport path.

54. The apparatus according to claim 35, wherein the or each output station is configured and adapted for vertically and/or horizontally discharging the containers from the stunning chamber.

55. The apparatus according to claim 36, wherein one of the lift devices is provided at a beginning and/or at an end of the transport path of each of the at least one transport conveyor, in order to configure and adapt a vertical transport of the containers.

56. A method for gas-stunning live poultry which are intended for slaughter and are located in containers, by a gas mixture containing a stunning gas, comprising the steps:
feeding the containers containing the live poultry to a stunning chamber by at least one input station, wherein the stunning chamber is arranged above ground;
transporting the containers through at least two stunning zones of the stunning chamber, which are arranged substantially horizontally one above the other, by a transport device having at least one transport conveyor;
wherein;
the gas mixture of the at least two stunning zones has different concentrations of the stunning gas in each of the stunning zones; and
the concentration of the stunning gas in the gas mixture of the at least two stunning zones increases, starting from an uppermost of the stunning zones to a lowermost of the stunning zones;
discharging the containers containing stunned poultry by an output station;
wherein;
the containers are transported by the transport device on the at least one transport path through the at least two stunning zones in a substantially horizontally meandering manner along a stunning path into the stunning chamber.

57. The method according to claim 56, wherein the containers are transported substantially vertically, at least in sections, by at least one lift device comprising the transport device, the input station and/or the output station.

58. The method according to claim 56, wherein the containers are transported on the stunning path substantially horizontally in a meandering manner, wherein the at least two stunning zones are arranged substantially horizontal one above the other in a meandering manner.

59. The method according to claim 57, wherein the containers are transported substantially horizontally through the at least two stunning zones, each by at least one of the transport conveyors, wherein the at least one lift device transports the containers substantially vertically between at least two of the transport conveyors.

60. The method according to claim 57, wherein, in a course of the stunning path, the containers are transported by the at least one lift device between at least two of the stunning zones located one above the other and having at least one transport path, in order to configure and adapt a vertical transport of the containers between at least two stunning zones, wherein at least one of the transport paths is bypassed.

61. The method according to claim 60, wherein bypassing the containers of at least one of the transport paths reduces the stunning path provided for transport of the containers.

62. The method according to claim 56, wherein a gas and/or a gas mixture is provided in the stunning chamber by at least one gassing device.

63. The method according to claim 62, wherein a gas mixture with a first concentration of a stunning gas is provided in the lowermost of the at least two stunning zones by the at least one gassing device.

64. The method according to claim 62, wherein in at least one of the stunning zones, preferably in the lowermost of the stunning zones, oxygen and/or an oxygen-containing gas mixture is provided by the at least one gassing device, in order to configure and adapt an oxygen-containing gas mixture with a concentration of the stunning gas.

65. The method according to claim 56, wherein, in the stunning chamber, a gas flow of at least one gas and/or a gas mixture is provided from a first one of the stunning zones to another of the stunning zones by at least one gas flow device, preferably from the lowermost stunning zone to at least one of the stunning zones above the lowermost stunning zone.

66. The method according to claim 56, wherein the containers each pass through at least three stunning zones one after the other along the stunning path in a substantially horizontal direction, namely a first phase I with a concentration of 5-25% stunning gas in the gas mixture, a second phase II with a concentration of 25-50% stunning gas in the gas mixture and a third phase III with a concentration of 50-100% stunning gas in the gas mixture.

67. The method according to claim 66, wherein in the stunning zones with phases I to III, possible fluctuations in the concentration of stunning gas in the gas mixture are compensated by increasing or reducing the concentration of stunning gas in the gas mixture, preferably by feeding in at least one gas and/or gas mixture using at least one gassing device.

68. The method according to claim 56, wherein the gas concentration of the stunning gas in the gas mixture is monitored in at least one of the at least two stunning zones.
